(19) United States
(12) Patent Application Publication
(10) Pub. No.: US 2005/0081890 A1
(43) Pub. Date: Apr. 21, 2005

(54) Dehydration drying method and apparatus, and substrate processing apparatus

(76) Inventors: Koji Ato, Tokyo (JP); Tetsuji Togawa, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/503,054

(22) PCT Filed: Mar. 5, 2003
(86) PCT No.: PCT/JP03/02553

(30) Foreign Application Priority Data
Mar. 8, 2002 (JP) 2002-063244

(51) Int. Cl. B08B 5/04

(52) U.S. Cl. 134/21; 134/26; 134/37; 134/33

(57) ABSTRACT

A dehydration drying method dehydrates and dries a substrate. The substrate (15) is dehydrated and dried without being rotated while the substrate (15) is accommodated in a carrier (10) operable to carry the substrate (15) between apparatuses for carrying out certain processes.

### TECHNICAL FIELD

The present invention relates to a dehydration drying method, a dehydration drying apparatus, and a substrate processing apparatus for dehydrating and drying a substrate which has been processed in a wet process used in a semiconductor fabrication process or the like.

### BACKGROUND ART

Heretofore, in a semiconductor fabrication process, it has been customary to dehydrate and dry a substrate which has been processed in a wet process by a spin-drying process in which the substrate is rotated at a high speed by a spin dryer to remove water attached to a surface of the substrate under a centrifugal force or an N₂ gas blow process in which an N₂ gas is blown to the substrate to dry the substrate.

Recently, as the processing speed of a semiconductor device becomes higher, a so-called low-k film has been used as an insulating film to be formed on a substrate. Many of such low-k films have a porous structure and the property of hydrophilicity and water absorption depending on their production processes. In a semiconductor fabrication process, when a substrate having such a low-k film thereon is processed in a wet process such as a cleaning process using ultrapure water or the like and is then dehydrated and dried by the spin-drying process or the N₂ gas blow process described above, water molecules tend to remain in the low-k film.

Such water molecules remaining in the low-k film are problematic in that the remaining water molecules cause the low-k film to swell and thus to be deformed. Further, when a subsequent process of the substrate is carried out under a high vacuum or an ultrahigh vacuum, a degree of vacuum that is required in the subsequent process cannot be achieved due to the water molecules remaining in the low-k film.

### DISCLOSURE OF INVENTION

The present invention has been made in view of the above drawbacks. It is therefore an object of the present invention to provide a dehydration drying method, a dehydration drying apparatus, and a substrate processing apparatus which can remove water remaining in a film having water-absorption property such as a low-k film used as an insulating film formed on a substrate, and dry such film and the substrate.

In order to achieve the above object, according to one aspect of the present invention, there is provided a dehydration drying method for dehydrating and drying a substrate, comprising: dehydrating and drying a substrate while the substrate is accommodated in a carrier operable to carry the substrate.

In a preferred aspect of the present invention, the substrate accommodated in the carrier is dehydrated and dried without being rotated.

In a preferred aspect of the present invention, the carrier is operable to carry the substrate between apparatuses for carrying out certain processes.

Since the substrate is dehydrated and dried without being rotated in such a state the substrate is accommodated in the carrier operable to carry the substrate between the apparatuses, the substrate can be dehydrated and dried separately from other processes of the substrate, and hence a substrate processing time of a substrate processing apparatus is not affected by such dehydration and drying process. In addition, in the case where the substrate has a porous film having water-absorption property such as a low-k film thereon, for example, water existing in the porous film can sufficiently be removed, and hence the porous film can be prevented from swelling and thus being deformed. Further, when a subsequent process of the substrate is carried out under a high vacuum or an ultrahigh vacuum, since the substrate has been dehydrated and dried sufficiently, a degree of vacuum that is required in such process can be achieved.

In a preferred aspect of the present invention, the substrate accommodated in the carrier is dehydrated and dried by being exposed to a vacuum.

In a preferred aspect of the present invention, the substrate accommodated in the carrier is dehydrated and dried by being exposed to a dry gas.

In a preferred aspect of the present invention, the substrate accommodated in the carrier is dehydrated and dried by being heated, or being exposed to a vacuum and/or a dry gas and being heated in combination.

Since the substrate accommodated in the carrier is dehydrated and dried by being exposed to a vacuum, or being exposed to a dry gas, or being exposed to a vacuum and/or a dry gas and being heated in combination, water existing in a porous film having water-absorption property such as a low-k film formed on the substrate can effectively be removed.

In a preferred aspect of the present invention, a dehydration drying method further comprises preliminarily drying the substrate before the substrate is accommodated in the carrier.

In a preferred aspect of the present invention, the substrate is preliminarily dried by a spin-drying process.

Since the substrate is preliminarily dried (e.g. spin-dried) before the substrate is accommodated in the carrier, water attached to a surface of the substrate is removed by the preliminary drying process. Remaining water, e.g., water existing in a porous film having water-absorption property such as a low-k film formed on the substrate is effectively removed while the substrate is dehydrated and dried in the carrier. Further, since most of the water has already been removed from the substrate by the preliminary drying process, the dehydrating and drying load in the carrier can be reduced.

In a preferred aspect of the present invention, the substrate has a film having water-absorption property.

In the case where a film having water-absorption property is formed on the substrate, particularly in the case where a film having water-absorption property is exposed on the surface of the substrate, water existing in such film cannot easily be removed by a spin-drying process or the like. In the present invention, since the substrate is dehydrated and dried while the substrate is accommodated in the carrier operable to carry the substrate between the apparatuses, the substrate can be dehydrated and dried without affecting the substrate processing time of the substrate processing apparatus, and hence the water existing in the film having water-absorption property can sufficiently be removed. Further, when a subsequent process of the substrate is carried out under a high vacuum or an ultrahigh vacuum, since the substrate has been dehydrated and dried sufficiently, a degree of vacuum that is required in such process can be achieved.

According to another aspect of the present invention, there is provided a dehydration drying apparatus for dehydrating and drying a substrate, comprising: a dehydration drying device for dehydrating and drying a substrate while the substrate is accommodated in a carrier operable to carry the substrate.

In a preferred aspect of the present invention, the substrate accommodated in the carrier is dehydrated and dried without being rotated.

In a preferred aspect of the present invention, the carrier is operable to carry the substrate between apparatuses for carrying out certain processes.

In a preferred aspect of the present invention, the dehydration drying device dehydrates and dries the substrate accommodated in the carrier by exposing the substrate to a vacuum.

In a preferred aspect of the present invention, the dehydration drying device dehydrates and dries the substrate accommodated in the carrier by exposing the substrate to a dry gas.

In a preferred aspect of the present invention, the dehydration drying device dehydrates and dries the substrate accommodated in the carrier by heating the substrate, or exposing the substrate to a vacuum and/or a dry gas and heating the substrate in combination.

Since the substrate is dehydrated and dried by the dehydration drying device without being rotated while the substrate is accommodated in the carrier operable to carry the substrate between apparatuses, the substrate can be dehydrated and dried separately from other processes of the substrate, and hence a substrate processing time of a substrate processing apparatus is not affected by such dehydration and drying process. In addition, in the case where the substrate has a porous film having water-absorption property such as a low-k film thereon, for example, water existing in the porous film can sufficiently be removed, and hence the porous film is prevented from swelling and thus being deformed. Further, when a subsequent process of the substrate is carried out under a high vacuum or an ultrahigh vacuum, since the substrate has been dehydrated and dried sufficiently, a degree of vacuum that is required in such process can be achieved. Because the substrate accommodated in the carrier is dehydrated and dried by being exposed to a vacuum, or being exposed to a dry gas, or being heated, or being exposed to a vacuum and/or dry gas and being heated in combination, water existing in a porous film having water-absorption property such as a low-k film formed on the substrate can effectively be removed.

According to another aspect of the present invention, there is provided a substrate processing apparatus for processing a substrate, comprising: a dehydration drying apparatus for dehydrating and drying a substrate which has been processed in a process; wherein the dehydration drying apparatus comprises a dehydration drying device for dehydrating and drying the substrate while the substrate is accommodated in a carrier operable to carry the substrate.

In a preferred aspect of the present invention, the substrate accommodated in the carrier is dehydrated and dried without being rotated.

In a preferred aspect of the present invention, the carrier is operable to carry the substrate between apparatuses for carrying out certain processes.

In a preferred aspect of the present invention, the dehydration drying device dehydrates and dries the substrate accommodated in the carrier by exposing the substrate to a vacuum.

In a preferred aspect of the present invention, the dehydration drying device dehydrates and dries the substrate accommodated in the carrier by exposing the substrate to a dry gas.

In a preferred aspect of the present invention, the dehydration drying device dehydrates and dries the substrate accommodated in the carrier by heating the substrate, or exposing the substrate to a vacuum and/or a dry gas and heating the substrate in combination.

As described above, since the substrate which has been processed is dehydrated and dried by the dehydration drying apparatus, the substrate processing time of the substrate processing apparatus is not affected by such dehydration and drying process. In addition, water remaining in a porous film having water-absorption property such as a low-k film formed on the substrate can sufficiently be removed to dehydrate and dry the substrate.

According to another aspect of the present invention, there is provided a polishing method comprising: polishing a substrate to form a polished substrate; cleaning and drying the polished substrate to form a clean and dried substrate; and dehydrating and drying the clean and dried substrate by a vacuum drying device.

In a preferred aspect of the present invention, the substrate has a film having water-absorption property and used as an insulating material.

According to another aspect of the present invention, there is provided a polishing method comprising: polishing a substrate to form a polished substrate; cleaning and drying the polished substrate to form a clean and dried substrate; and dehydrating and drying the clean and dried substrate by a heat drying device.

In a preferred aspect of the present invention, the substrate has a film having water-absorption property and used as an insulating material.

According to another aspect of the present invention, there is provided a polishing method comprising: polishing a substrate which has a film having water-absorption property and used as an insulating material to form a polished substrate; cleaning and drying the polished substrate to form a clean and dried substrate; and removing water remaining in the film to dehydrate and dry the clean and dried substrate.

### BRIEF DESCRIPTION OF DRAWINGS

FIG. 1A is a schematic cross-sectional view of a dehydration drying apparatus whose carrier body is connected to a vacuum source through a check valve to develop a vacuum in a carrier according to a first embodiment of the present invention;

FIG. 1B is a schematic cross-sectional view of a dehydration drying apparatus whose carrier body is disconnected from the vacuum source while a developed vacuum is maintained in the carrier according to the first embodiment of the present invention;

FIG. 2 is a schematic cross-sectional view of a dehydration drying apparatus according to a second embodiment of the present invention;

FIG. 3 is a schematic cross-sectional view of a dehydration drying apparatus according to a third embodiment of the present invention;

FIG. 4 is a schematic view of a substrate processing apparatus having a dehydration drying apparatus according to a fourth embodiment of the present invention;

FIG. 5 is a schematic view of a substrate processing apparatus having a dehydration drying apparatus according to a fifth embodiment of the present invention; and

FIG. 6 is a schematic view of a substrate processing apparatus having a dehydration drying apparatus according to a sixth embodiment of the present invention.

### BEST MODE FOR CARRYING OUT THE INVENTION

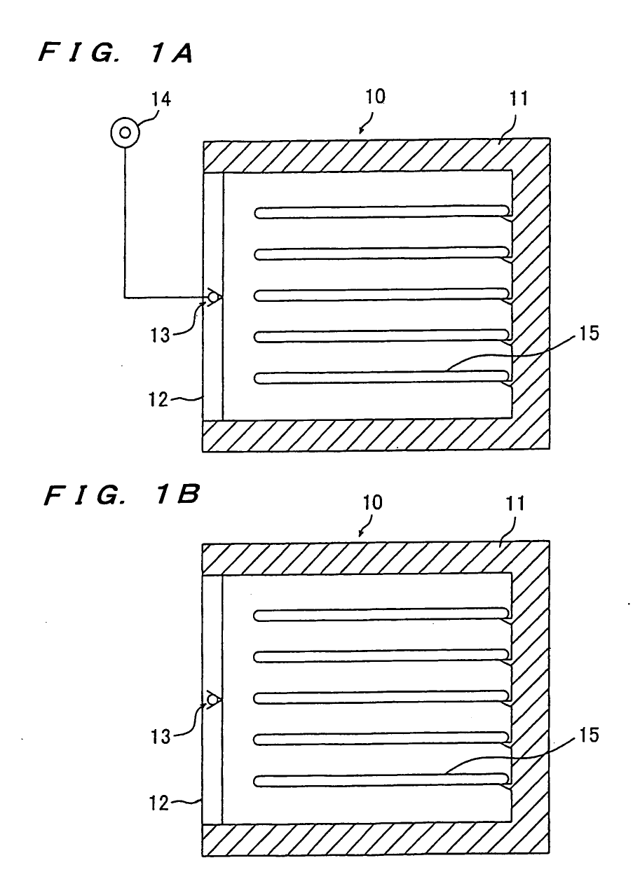

A dehydration drying method, a dehydration drying apparatus, and a substrate processing apparatus according to embodiments of the present invention will be described below with reference to the drawings. FIGS. 1A and 1B are schematic cross-sectional views showing a dehydration drying apparatus for carrying out a method of dehydrating and drying a substrate according to a first embodiment of the present invention. As shown in FIGS. 1A and 1B, a carrier 10 serves to accommodate and carry substrates 15 between apparatuses of a semiconductor fabrication facility. The carrier 10 comprises a carrier body (body member) 11 having an opening defined in a side wall thereof, and a lid 12 for closing the opening of carrier body 11 hermetically. The lid 12 has a check valve 13 for allowing an interior space of the carrier body 11 to communicate with a vacuum source 14. The carrier body 11 can accommodate a plurality of substrates 15 therein at predetermined vertical intervals.

As shown in FIG. 1A, the substrates 15 are accommodated and placed in the carrier body 11 of the carrier 10. The carrier body 11 is connected to the vacuum source 14 through the check valve 13. The interior space of the carrier body 11 is evacuated by the vacuum source 14 to develop a high vacuum therein, and hence the substrates 15 accommodated in the carrier body 11 are exposed to the high vacuum. Therefore, for example, after a wet process such as a cleaning process using ultrapure water or the like is carried out, water remaining in a porous film having hydrophilic property and/or water-absorption property such as a low-k film formed on a surface of each of the substrates 15 is removed to dry the film and the substrates 15. In the case where such film having hydrophilic property and/or water-absorption property is exposed on the surface of each of the substrates 15, since the film captures water molecules during the wet process, the substrates 15 are required to be dehydrated and dried sufficiently. Therefore, after the wet process is carried out, the substrates 15 should preferably be dried preliminarily by a preliminary drying process such as a spin drying process before the substrates 15 are accommodated in the carrier 10, so that any load on the carrier 10 for dehydrating and drying the substrates 15 can be reduced and the substrates 15 can sufficiently be dehydrated and dried. The preliminary drying process may be an N₂ gas blow process, a Marangoni drying process, a pull-up drying process using IPA (isopropyl alcohol), or the like.

After the substrates 15 are dehydrated and dried, the vacuum source 14 is disconnected from the check valve 13, as shown in FIG. 1B, and the developed vacuum is maintained in the carrier 10. Although the check valve 13 is provided in the lid 12 in the present embodiment, the check valve 13 may be provided in a side wall of the carrier body 11.

Although not shown in the drawings, the substrates 15 may be heated by introducing a high-temperature N₂ gas or the like into the carrier 10 or applying radiant heat to the substrates 15 from a radiant heat source. Alternatively, radiant heat may be applied to the substrates 15 to heat the substrates 15 while a vacuum is maintained in the carrier 10. Further, the substrates 15 may be exposed to a vacuum, a dry gas, or a high-temperature gas, or may be heated, or may be subjected to such exposure and such heating in combination. Specifically, the carrier body 11 is connected to the vacuum source 14 to develop a vacuum in the carrier 10, and the substrates 15 are dehydrated and dried under the vacuum in the carrier 10. Thereafter, a dry gas or a high-temperature gas such as a high-temperature N₂ gas is introduced into the carrier body 11 to heat the substrates 15. In this manner, the substrates 15 can effectively be dehydrated and dried. In the above embodiment, the opening of the carrier body 11 is closed by the lid 12 to make the interior space of the carrier 10 airtight. Alternatively, the carrier 10 may be covered in its entirety with a cover to make the interior space of the carrier 10 airtight.

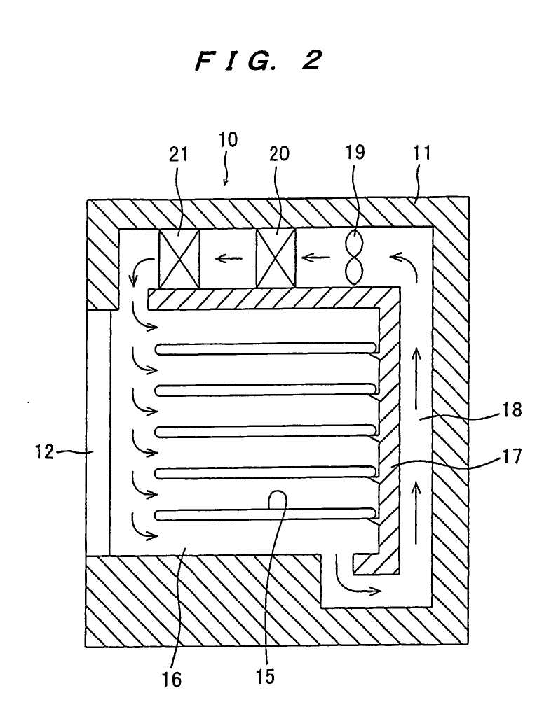

FIG. 2 shows a schematic cross-sectional view of a dehydration drying apparatus for carrying out a method of dehydrating and drying a substrate according to a second embodiment of the present invention. As shown in FIG. 2, a carrier 10 serves to accommodate and carry substrates 15 between apparatuses of a semiconductor fabrication facility. The carrier 10 comprises a carrier body 11, having an opening defined in a side wall thereof, and a lid 12 for closing the opening of the carrier body 11 to make the interior space of the carrier 10 airtight. The carrier body 11 has a substrate storage chamber 16 therein for accommodating a plurality of the substrates 15 at predetermined vertical intervals. A gas circulation passage 18 is provided between a side wall 17 of the substrate storage chamber 16 and an inner wall surface of the carrier body 11. The gas circulation passage 18 houses therein a fan 19, a dehydration filter 20, and a HEPA filter 21. The dehydration filter 20 serves as a filter for removing water from a gas, and the HEPA filter 21 serves as an air filter for trapping and removing particles from a gas.

The dehydration drying apparatus shown in FIG. 2 operates as follows: The substrates 15 are accommodated and placed in the substrate storage chamber 16 provided in the carrier body 11, and the opening of the carrier body 11 is closed by the lid 12 to hermetically seal the interior space of the carrier 10. A dry gas such as a dry N₂ gas is introduced into the carrier 10, and the fan 19 is driven to circulate the dry gas in the substrate storage chamber 16 through the gas circulation passage 18. In this manner, the circulating dry gas effectively removes water from each of the substrates 15, particularly water remaining in a porous film having hydrophilic property and/or water-absorption property formed on each of the substrates 15, thereby dehydrating and drying the porous film and the substrates 15. Water contained in the circulating gas is removed by the dehydration filter 20, and particles contained in the circulating gas are removed by the HEPA filter 21. In the second embodiment, the opening of the carrier body 11 is closed by the lid 12 to make the interior space of the carrier 10 airtight. Alternatively, the carrier 10 may be covered in its entirety with a cover to make the interior space of the carrier 10 airtight.

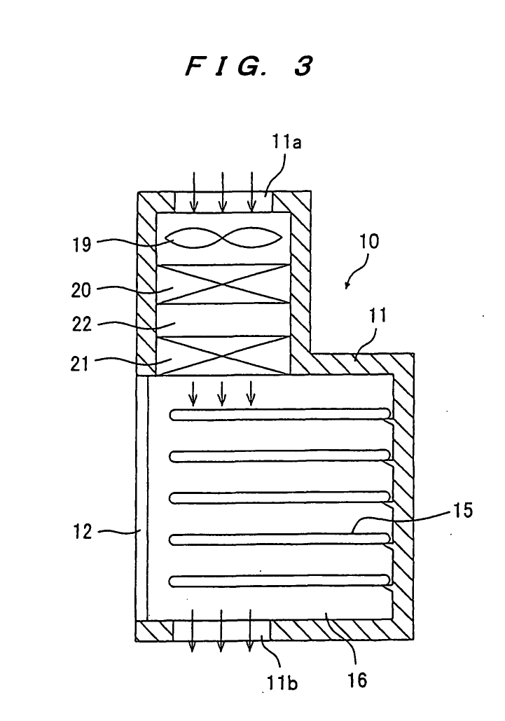

FIG. 3 shows a schematic cross-sectional view of a dehydration drying apparatus for carrying out a method of dehydrating and drying a substrate according to a third embodiment of the present invention. As shown in FIG. 3, a carrier 10 serves to accommodate and carry substrates 15 between apparatuses of a semiconductor fabrication facility. The carrier 10 comprises a carrier body 11 having an opening defined in a side wall thereof, and a lid 12 for closing the opening of carrier body 11 to make the interior space of the carrier 10 airtight. The carrier body 11 has a substrate storage chamber 16 therein for accommodating a plurality of substrates 15 at predetermined vertical intervals. A gas introduction chamber 22 is provided above the substrate storage chamber 16. A fan 19, a dehydration filter 20, and a HEPA filter 21 are provided in the gas introduction chamber 22, and are successively arranged therein. The carrier body 11 has an opening 11a defined in an upper wall thereof above the gas introduction chamber 22, and an opening 11b defined in a bottom wall thereof below the substrate storage chamber 16.

The dehydration drying apparatus shown in FIG. 3 operates as follows: The substrates 15 are accommodated and placed in the substrate storage chamber 16 of the carrier 10, and the opening of the carrier body 11 is closed by the lid 12 to hermetically seal the interior space of the carrier 10. Thereafter, the fan 19 is driven to introduce a dry gas or a high-temperature gas through the opening 11a into the gas introduction chamber 22. Water and particles contained in the gas are removed by the dehydration filter 20 and the HEPA filter 21. The gas is introduced through the gas introduction chamber 22 into the substrate storage chamber 16, and is then discharged from the opening 11b. In this manner, water on each of the substrates 15 accommodated in the substrate storage chamber 16, particularly water which exists in a porous film having hydrophilic property and/or water-absorption property formed on each of the substrates 15, can effectively be removed, thereby dehydrating and drying the substrates 15.

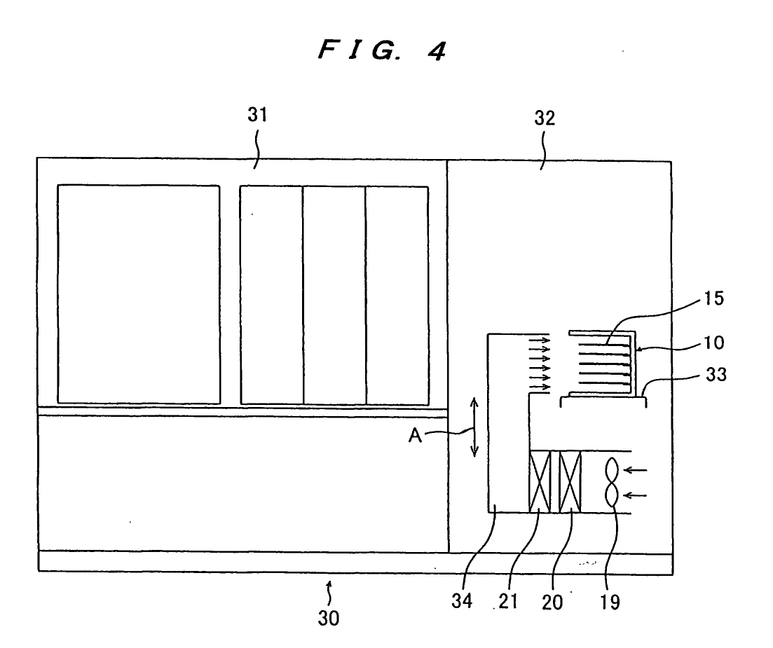

FIG. 4 shows a schematic view of a substrate processing apparatus having a dehydration drying apparatus for carrying out a method of dehydrating and drying a substrate according to a fourth embodiment of the present invention. As shown in FIG. 4, a substrate processing apparatus 30 comprises a substrate processing chamber 31 in which various types of processes including a wet process such as cleaning are carried out, and a loading/unloading (L/UL) chamber 32 disposed adjacent to the substrate processing chamber 31 for loading and unloading a carrier 10 accommodating substrates 15 therein.

The loading/unloading chamber 32 comprises a carrier base 33 on which the carrier 10 accommodating the substrates 15 therein is placed. The loading/unloading chamber 32 also comprises a gas introduction passage 34 for supplying (blowing) a dry gas or a high-temperature gas to the substrates 15 accommodated in the carrier 10 that is placed on the carrier base 33. A fan 19, a dehydration filter 20, and a HEPA filter 21 are provided in the gas introduction passage 34.

The substrate processing apparatus 30 operates as follows: Various types of processes are carried out in the substrate processing chamber 31, and the substrates 15 that have been cleaned and spin-dried are transferred and placed in the carrier 10 by a robot or the like (not shown). At this state, the fan 19 disposed in the gas introduction passage 34 is driven to draw a dry gas or a high-temperature gas into the gas introduction passage 34. Water and particles contained in the gas are removed by the dehydration filter 20 and the HEPA filter 21, and a dry gas or a high-temperature gas is blown to the substrates 15 accommodated in the carrier 10. Therefore, water on each of the substrates 15, particularly water which exists in a porous film having hydrophilic property and/or water-absorption property formed on each of the substrates 15, can effectively be removed, thereby dehydrating and drying the substrates 15.

The gas introduction passage 34 can be moved upwardly and downwardly as indicated by the arrow A shown in FIG. 4. When the substrate 15 is transferred to or from the carrier 10 placed on the carrier base 33, the gas introduction passage 34 is moved downwardly. When the dry gas or the high-temperature gas is blown to the substrates 15, the gas introduction passage 34 is moved upwardly to a position where a gas outlet of the gas introduction passage 34 is aligned with the opening of the carrier 10.

In the embodiments shown in FIGS. 1A through 4, the substrates 15 are dehydrated and dried while the substrates 15 are accommodated in the carrier 10 without rotating the substrates 15 and the carrier 10. Therefore, since any mechanism for rotating the substrates 15 and/or the carrier 10 is not required, the structure of the dehydration drying apparatus can be simplified.

As shown in FIG. 4, a semiconductor fabrication apparatus generally comprises the substrate processing chamber 31 for processing a substrate, and the loading/unloading chamber 32 for transferring the substrate 15 to or from the substrate processing chamber 31 and also transferring the substrate 15 accommodated in the carrier 10 between the semiconductor fabrication apparatus and the exterior of the apparatus. One example of an apparatus having such a structure is a CMP (Chemical Mechanical Polishing) apparatus. In the CMP apparatus, generally, a substrate 15 is polished one by one in a polishing unit, and the substrate 15 which has been polished by the polishing unit is cleaned and dried (e.g. spin-dried), and is then returned to the carrier 10. In the CMP apparatus, a dry-in and dry-out method in which the carrier 10 having dry substrates 15 therein is introduced into the loading/unloading chamber 32 and the carrier 10 having processed dry substrates 15 is removed from the loading/unloading chamber 32 is employed.

As described above, the substrates 15 that are transferred from the substrate processing chamber 31 into the carrier 10 have already been dried by a spin-drying process or the like. However, the substrates 15 having a porous film such as a low-k film should preferably be further dehydrated and dried to remove water remaining in the porous film. Therefore, it is preferable to dehydrate and dry the substrates 15 by a process shown in FIG. 5.

As shown in FIG. 5, a substrate processing apparatus 40 comprises apparatuses for carrying out a first process 41 and a second process 42, and a vacuum drying device 43 for carrying out a subsequent dehydrating and drying process after the second process 42. A substrate 15 is polished by a polishing process as the first process 41, and is then cleaned and dried by a cleaning and drying (e.g. spin-drying) process as the second process 42. Thereafter, the substrate 15 is dehydrated and dried by the vacuum drying device 43, and is then transferred into the carrier 10.

The vacuum drying device 43 has a vacuum chamber for accommodating the substrate 15. The vacuum chamber accommodates the substrate 15 which has been cleaned and dried in the second process 42 and is evacuated to develop a high vacuum therein, so that the substrate 15 in the vacuum chamber is exposed to the high vacuum, for thereby vacuum-drying the substrate 15. In this manner, water remaining in a porous film having hydrophilic property and/or water-absorption property formed on the substrate 15 which has been cleaned and dried by spin-drying or the like in the second process 42 can be removed to dehydrate and dry the film sufficiently.

Although not shown in the drawings, the vacuum drying device 43 may be replaced with a heat drying device having a heat chamber for heating and drying a substrate. In the case where the heat drying device is used, the substrate 15 which has been cleaned and dried in the second process 42 is accommodated in the heat chamber, and the interior space of the heat chamber is heated to dry the substrate 15. In this case, since the oxidization of the substrate 15 is accelerated due to heat, the atmosphere in the heat chamber is required to be replaced with an inert gas. Irrespective of whether the vacuum drying device or the heat drying device is used, since it is necessary to keep the chamber airtight to evacuate the chamber or replace the atmosphere in the chamber with the inert gas, the drying device should preferably comprise a single substrate processing mechanism for processing a substrate one by one because such mechanism requires a small-volume chamber.

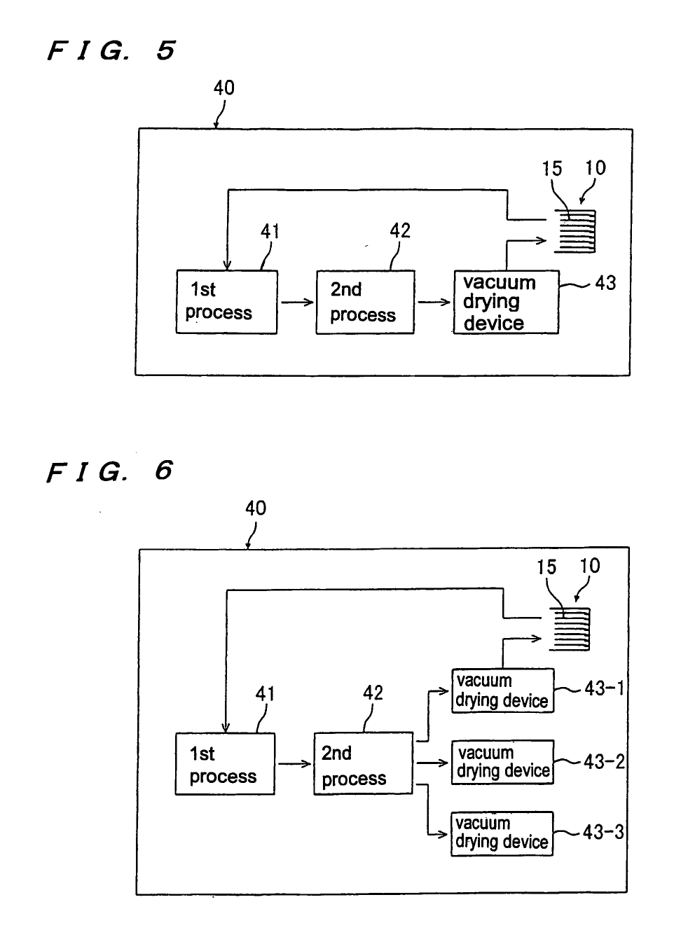

The above method using the vacuum drying device 43 requires a long processing time in developing a vacuum in the vacuum chamber, and the method using the heat drying device requires a long processing time in heating the interior space of the heat chamber and cooling the heated interior space of the heat chamber. Therefore, it is preferable to use a process shown in FIG. 6.

As shown in FIG. 6, a substrate processing apparatus 40 comprises apparatuses for carrying out a first process 41 and a second process 42, and three vacuum drying devices 43-1, 43-2 and 43-3 disposed downstream of the second process 42. Substrates 15 which have been cleaned and dried by the second process 42 are distributed and accommodated in the three vacuum drying devices 43-1, 43-2 and 43-3, and are then dehydrated and dried concurrently by the three vacuum drying devices 43-1, 43-2 and 43-3.

With the substrate processing apparatus 40 shown in FIG. 6, if the tact times of the first process (polishing process) 41 and the second process (cleaning and drying process) 42 are short, then the substrates 15 can be processed without a reduction in the processing speed of the substrate processing apparatus 40. However, in this case, the substrate processing apparatus 40 having the three vacuum drying devices 43-1, 43-2 and 43-3 tends to be large in size. The vacuum drying devices 43-1, 43-2 and 43-3 may be replaced with heat drying devices having a heat chamber for heating and drying a substrate, respectively.

As shown in FIG. 5, the substrate processing apparatus 40 in which the single vacuum drying device 43 or the single heat drying device is disposed downstream of the second process (cleaning and drying process) 42 requires a long processing time. As shown in FIG. 6, the substrate processing apparatus 40 in which the three vacuum drying devices 43-1, 43-2 and 43-3 or the three heat drying devices are disposed downstream of the second process (cleaning and drying process) 42 tends to be large in size. The apparatus for dehydrating and drying the substrates 15 accommodated in the carrier 10 as shown in FIGS. 1A through 3 can dehydrate and dry the substrates without an increase in both the processing time and the size of the apparatus.

The substrate processing apparatus according to the present invention may be applied to an apparatus having a wet process such as a wet etching apparatus, a cleaning apparatus, and the like, as well as the CMP apparatus.

Although the substrate having a film such as a low-k film has been described in the above embodiments, the present invention is applicable to a substrate having no film, a substrate having interconnections, and other substrates.

According to the present invention, the following excellent advantages can be obtained:

1) Since the substrate is dehydrated and dried without being rotated in such a state that the substrate is accommodated in the carrier operable to carry the substrate between apparatuses for carrying out certain processes, the substrate can be dehydrated and dried separately from other processes of the substrate, and hence a substrate processing time of a substrate processing apparatus is not affected by such dehydration and drying process. In addition, in the case where the substrate has a porous film having water-absorption property such as a low-k film thereon, for example, water existing in the porous film can sufficiently be removed, and hence the porous film can be prevented from swelling and thus being deformed. Further, when a subsequent process of the substrate is carried out under a high vacuum or an ultrahigh vacuum, since the substrate has been dehydrated and dried sufficiently, a degree of vacuum that is required in such process can be achieved.

2) Since the substrate accommodated in the carrier is dehydrated and dried by being exposed to a vacuum, or being exposed to a dry gas, or being exposed to a vacuum and/or a dry gas and being heated in combination, water existing in a porous film having water-absorption property such as a low-k film formed on the substrate can effectively be removed.

3) Since the substrate is preliminarily dried (e.g. spin-dried) before the substrate is accommodated in the carrier, water attached to a surface of the substrate is removed by the preliminary drying process. Remaining water, e.g., water existing in a porous film having water-absorption property such as a low-k film formed on the substrate is effectively removed while the substrate is dehydrated and dried in the carrier. Further, since most of the water has already been removed from the substrate by the preliminary drying process, the dehydrating and drying load in the carrier can be reduced, and hence the substrate can be dehydrated and dried sufficiently.

4) In the case where a film having water-absorption property is formed on the substrate, particularly in the case where a film having water-absorption property is exposed on the surface of the substrate, water existing in such film cannot easily be removed by a spin-drying process or the like. In the present invention, since the substrate is dehydrated and dried while the substrate is accommodated in the carrier operable to carry the substrate between the apparatuses, the substrate can be dehydrated and dried without affecting the substrate processing time of the substrate processing apparatus, and hence the water existing in the film having water-absorption property can sufficiently be removed. Further, when a subsequent process of the substrate is carried out under a high vacuum or an ultrahigh vacuum, since the substrate has been dehydrated and dried sufficiently, a degree of vacuum that is required in such process can be achieved.

5) In the dehydration drying apparatus according to the present invention, since the substrate is dehydrated and dried by the dehydration drying device without being rotated while the substrate is accommodated in the carrier operable to carry the substrate between apparatuses, the substrate can be dehydrated and dried separately from other processes of the substrate, and hence a substrate processing time of a substrate processing apparatus is not affected by such dehydration and drying process. In addition, in the case where the substrate has a porous film having water-absorption property such as a low-k film thereon, for example, water existing in the porous film can sufficiently be removed, and hence the porous film is prevented from swelling and thus being deformed. Further, when a subsequent process of the substrate is carried out under a high vacuum or an ultrahigh vacuum, since the substrate has been dehydrated and dried sufficiently, a degree of vacuum that is required in such process can be achieved. Because the substrate accommodated in the carrier is dehydrated and dried by being exposed to a vacuum, or being exposed to a dry gas, or being exposed to a vacuum and/or a dry gas and being heated in combination, water existing in a porous film having water-absorption property such as a low-k film formed on the substrate can effectively be removed.

6) In the substrate processing apparatus according to the present invention, since the substrate which has been processed is dehydrated and dried by the dehydration drying apparatus, the substrate processing time of the substrate processing apparatus is not affected by such dehydration and drying process. In addition, water remaining in a porous film having water-absorption property such as a low-k film formed on the substrate can sufficiently be removed to dehydrate and dry the substrate. Further, it is not necessary to install a mechanism for dehydrating and drying the substrate within the substrate processing apparatus, and hence the substrate processing apparatus can be prevented from being large in size.

### Industrial Applicability

The present invention is applicable to a dehydration drying method, a dehydration drying apparatus, and a substrate processing apparatus capable of dehydrating and drying a substrate which has been processed in a wet process used in a semiconductor fabrication process or the like.

1. A dehydration drying method for dehydrating and drying a substrate, comprising:
dehydrating and drying a substrate while the substrate is accommodated in a carrier operable to carry the substrate.

2. A dehydration drying method according to claim 1, wherein the substrate accommodated in said carrier is dehydrated and dried without being rotated.

3. A dehydration drying method according to claim 1, wherein said carrier is operable to carry the substrate between apparatuses for carrying out certain processes.

4. A dehydration drying method according to claim 1, wherein the substrate accommodated in said carrier is dehydrated and dried by being exposed to a vacuum.

5. A dehydration drying method according to claim 1, wherein the substrate accommodated in said carrier is dehydrated and dried by being exposed to a dry gas.

6. A dehydration drying method according to claim 1, wherein the substrate accommodated in said carrier is dehydrated and dried by being heated, or being exposed to a vacuum and/or a dry gas and being heated in combination.

7. A dehydration drying method according to claim 1, further comprising:
preliminarily drying the substrate before the substrate is accommodated in said carrier.

8. A dehydration drying method according to claim 7, wherein the substrate is preliminarily dried by a spin-drying process.

9. A dehydration drying method according to claim 1, wherein the substrate has a film having water-absorption property.

10. A dehydration drying apparatus for dehydrating and drying a substrate, comprising:
a dehydration drying device for dehydrating and drying a substrate while the substrate is accommodated in a carrier operable to carry the substrate.

11. A dehydration drying apparatus according to claim 10, wherein the substrate accommodated in said carrier is dehydrated and dried without being rotated.

12. A dehydration drying apparatus according to claim 10, wherein said carrier is operable to carry the substrate between apparatuses for carrying out certain processes.

13. A dehydration drying apparatus according to claim 10, wherein said dehydration drying device dehydrates and dries the substrate accommodated in said carrier by exposing the substrate to a vacuum.

14. A dehydration drying apparatus according to claim 10, wherein said dehydration drying device dehydrates and dries the substrate accommodated in said carrier by exposing the substrate to a dry gas.

15. A dehydration drying apparatus according to claim 10, wherein said dehydration drying device dehydrates and dries the substrate accommodated in said carrier by heating the substrate, or exposing the substrate to a vacuum and/or a dry gas and heating the substrate in combination.

16. A substrate processing apparatus for processing a substrate, comprising:
a dehydration drying apparatus for dehydrating and drying a substrate which has been processed in a process;
wherein said dehydration drying apparatus comprises a dehydration drying device for dehydrating and drying the substrate while the substrate is accommodated in a carrier operable to carry the substrate.

17. A substrate processing apparatus according to claim 16, wherein the substrate accommodated in said carrier is dehydrated and dried without being rotated.

18. A substrate processing apparatus according to claim 16, wherein said carrier is operable to carry the substrate between apparatuses for carrying out certain processes.

19. A substrate processing apparatus according to claim 16, wherein said dehydration drying device dehydrates and dries the substrate accommodated in said carrier by exposing the substrate to a vacuum.

20. A substrate processing apparatus according to claim 16, wherein said dehydration drying device dehydrates and dries the substrate accommodated in said carrier by exposing the substrate to a dry gas.

21. A substrate processing apparatus according to claim 16, wherein said dehydration drying device dehydrates and dries the substrate accommodated in said carrier by heating the substrate, or exposing the substrate to a vacuum and/or a dry gas and heating the substrate in combination.

22. A polishing method comprising:
polishing a substrate to form a polished substrate;
cleaning and drying the polished substrate to form a clean and dried substrate; and
dehydrating and drying the clean and dried substrate by a vacuum drying device.

23. A polishing method according to claim 22, wherein the substrate has a film having water-absorption property and used as an insulating material.

24. A polishing method comprising:
polishing a substrate to form a polished substrate;
cleaning and drying the polished substrate to form a clean and dried substrate; and
dehydrating and drying the clean and dried substrate by a heat drying device.

25. A polishing method according to claim 24, wherein the substrate has a film having water-absorption property and used as an insulating material.

26. A polishing method comprising:
polishing a substrate which has a film having water-absorption property and used as an insulating material to form a polished substrate;
cleaning and drying the polished substrate to form a clean and dried substrate; and
removing water remaining in said film to dehydrate and dry the clean and dried substrate.
